(19) United States
(12) Patent Application Publication
(10) Pub. No.: US 2022/0045917 A1
(43) Pub. Date: Feb. 10, 2022

(54) SYSTEM AND METHOD FOR OBTAINING HIGHER QUALITY OF EXPERIENCE AND DESIRED NETWORK SLICE BY UTILIZING FEEDBACK

(71) Applicant: TAMBORA SYSTEMS SINGAPORE PTE. LTD, SINGAPORE (SG)

(72) Inventors: ANAND UPPILI, BENGALURU (IN); GANESH VAIDYANATHAN RAMACHANDRAN, CHENNAI (IN); VIKAS DAYANAND WARAD, BENGALURU (IN); RAGHU GOVARDHANA, BENGALURU (IN); MAHESH KUMAR ONKARAPPA CHINDI, BENGALURU (IN)

(21) Appl. No.: 17/349,967

(22) Filed: Jun. 17, 2021

(30) Foreign Application Priority Data
Aug. 4, 2020 (IN) 202041033362

(51) Int. Cl. H04L 12/24; H04W 24/08

(52) U.S. Cl. CPC H04L 41/5067; H04W 24/08

(57) ABSTRACT

An end user device connected to a network is comprises a memory unit, a processor operably coupled to the memory unit, and a client application stored in the memory unit. A sensing module processor senses inputs from one or more sources. The sources comprise points in the network, software applications running on the end user device, software integrated in an operating system of the end user device, and the processor of the end user device. A processing module processes the sensed inputs to determine changes in parameters of the network for enabling the network to provide either a particular quality of experience or a particular network slice. An acting module provides the determined changes as feedback to a server connected to the network. In response, the server effects the determined changes in the parameters of the network for providing either the particular quality of experience or the particular network slice.

### CROSS REFERENCE TO RELATED APPLICATIONS

This application claims priority to and the benefit of the non-provisional application number 202041033362, filed in the Indian Patent Office on Aug. 4, 2020, entitled “System and Method for Obtaining Higher Quality of Experience and Desired Network Slice by Utilizing Feedback,” which application is incorporated herein in its entirety by reference.

### BACKGROUND OF THE INVENTION

The modern age of internet is touching almost every part of digital life. With connectivity becoming ubiquitous, the number of internet applications as well as users has ballooned over the last few years and continues to grow at a phenomenal rate. Thus, the internet applications similar to any new-age ecosystems also face challenges with this phenomenal growth. One of the biggest challenges for the internet application is the assurance or guarantee of quality of experience, for example, un-buffered high quality video content or an ability to provide un-interrupted connectivity for an e-commerce site when the purchase is happening. Further, with the advent of new age applications, for example, internet of things (IoTs), and self-driving vehicles, the quality of experience moves from just assuring bandwidth to other factors such as latency, assured connectivity and so on.

Till the present date, the internet applications and the network infrastructure providing the desired connectivity work in two silos i.e., the connectivity infrastructure of an end user network does not really know what internet application is running on an end user device, for example, a mobile device, in order to optimize the network parameters. On the other hand, the internet application also does not know on what network infrastructure the internet application is running on. Thus, there exists a need to receive the quality of experience requirements related to the internet applications running on the end user device, and to optimize the network infrastructure parameters of the end user network, so as to provide the required quality of experience for the internet applications running on the end user device. There also exists a need to provide the network with information of specific use cases for which the network is being used by the internet applications running on the end user device. More specifically, there exists a need for modifying parameters of the network to provide portions of the networks for each use case that suit the needs of the internet application that demands the use case.

Hence, there is a long felt but unresolved need for providing a guaranteed quality of experience to an internet application on the end user device. There also exists a need for a method for receiving the type of internet application running on the end user device, quality the end user device is experiencing along with the resource utilized of the end user network, and the content provider server associated with the corresponding internet application for providing the required quality of experience for the internet application running on the end user device.

### SUMMARY OF THE INVENTION

This summary is provided to introduce a selection of concepts in a simplified form that are further disclosed in the detailed description of the invention. This summary is not intended to determine the scope of the claimed subject matter.

The methods and systems disclosed herein address the above-mentioned need for providing a guaranteed quality of experience to a software application, for example, an internet application running on an end user device. The end user device is one of a mobile phone, a wireless internet connected device, a tablet, etc. In an embodiment, the end user device is an internet device that connects to the internet through a wired medium using an Ethernet port of the internet device.

An end user device connected to a network is provided. The end user device comprises a memory unit, a processor operably coupled to the memory unit, and a client application comprising computer readable instructions of an application awareness algorithm stored in the memory unit. The computer readable instructions are configured to be executed by the processor of the end user device. When the computer readable instructions are executed by the processor of the end user device, the software instructions cause the processor to sense, using a sensing module, inputs from one or more sources. The sources comprise one or more points in the network, one or more applications, for example, software applications, running on the end user device, software integrated in an operating system of the end user device, and firmware integrated in the processor of the end user device. Examples of points in the network comprise User Equipment, for example, end user devices; eNode-Bs/gNBs; P-GWs; Authentication Servers; DHCP servers; NAT equipment; Network Intelligence equipment; and interfaces to Content Distribution Network (CDN) or Content Provider Networks. In an embodiment, the processor of the end user device is a main processor of the end user device. The main processor is, for example, a “SoC (System on Chip)” processor. In another embodiment, the main processor is, for example, a network processor.

The software instructions further cause the processor to process, using a processing module, the sensed inputs to determine one or more changes in parameters of the network for providing a particular quality of experience (QoE) by the network to the user of the end user device. The software instructions further cause the processor to provide, using an acting module, the determined changes as feedback to a server connected to the network. In response, the server is configured to effect the one or more determined changes in the parameters of the network for providing the particular quality of experience (QoE).

In an embodiment, instead of determining changes in the parameters of the network for providing the particular quality of experience, the end user device determines one or more changes in the parameters of the network for providing a particular network slice by the network. The end user device provides the determined changes as feedback to the server connected to the network. The server is configured to effect the one or more determined changes in the parameters of the network for providing the particular network slice.

A method of providing feedback to a network for requesting a particular quality of experience (QoE) on an end user device connected to the network is disclosed. The method comprises providing an application awareness algorithm comprising computer readable instructions stored in a memory unit of the end user device. The computer readable instructions are configured to be executed by a processor of the end user device. The processor performs steps comprising sensing inputs from one or more sources. The one or more sources comprise one or more points in the network, one or more software applications running on the end user device, one or more software integrated in an operating system of the end user device, and firmware integrated in the processor of the end user device. Further, the processor processes the sensed inputs to determine one or more changes in parameters of the network for providing the particular quality of experience (QoE) by the network, and provides the determined changes as feedback to a server connected to the network. The server is configured to effect the one or more determined changes in the parameters of the network for providing the particular quality of experience.

In another embodiment, a method of providing feedback to a network for requesting a particular network slice on an end user device connected to the network is disclosed. In this method, instead of determining changes in the parameters of the network for providing the particular quality of experience (QoE), the method comprises determining one or more changes in the parameters of the network for providing the particular network slice by the network. The method further comprises providing the determined changes as feedback to a server connected to the network. The server is configured to effect the one or more determined changes in the parameters of the network for providing the particular network slice.

Also disclosed herein is an end user device operating system architecture for providing feedback to a network. The operating system comprises computer readable instructions stored in a memory unit of the end user device. The computer readable instructions are configured to be executed by a processor of the end user device. When the computer readable instructions are executed by the processor, they cause the processor to sense inputs from one or more software applications running on the end user device, and provide the sensed inputs as feedback to a server connected to the network. The server is configured to effect one or more changes in the parameters of the network.

In an embodiment, an end user device connected to a network is provided. The end user device comprises a memory unit and a processor. The processor is for example, a network processor. The memory unit is operably coupled to the processor. The memory unit comprises a client application comprising computer readable instructions of an application awareness algorithm. The computer readable instructions when executed by the processor cause the processor to sense inputs from one or more of a plurality of software applications running on the end user device, and provide the sensed inputs to a server connected to the network. The server is configured to effect one or more changes in the parameters of the network. The changes in the parameters of the network enable to network to provide a particular quality of experience to a user of the end user device. In an embodiment, the changes in the parameters of the network enable to network to provide a particular network slice to a software application running on the end user device.

Also disclosed herein is a server, for example, a centralized server, a cloud based server, etc., connected to an end user device through a network. The server comprises a memory device, a processor operably coupled to the memory device, and a peer software application stored in the memory device. The peer software application comprises computer readable instructions configured to be executed by the processor. In an embodiment, the peer software application is, for example, a server component of the application awareness algorithm in the client device. The computer readable instructions, on execution by the processor, cause the processor to receive inputs from one or more software applications each residing on an end user device. Here, the inputs correspond to one or more changes in parameters of the network. The computer readable instructions also cause the processor to process the received inputs in a rules engine to determine one or more changes in parameters of the network for the one or more end user devices comprising the software application. The computer readable instructions also cause the processor to interface with a function module of either a 4G or a 5G network and communicate the determined changes to the function module. The network is for example, a 4G network, a 5G Network, etc. If the network is a 4G network, the function module effects changes in the parameters of the network to improve Quality of Experience (QoE) for a specific end user device. If the network is a 5G network, the function module effects changes in the parameters of the network to provide a required network slice to a specific software application used by the one or more end user devices. In an embodiment, the function module also improves the QoE in a 5G network.

Also disclosed herein is a web application configured to be downloaded on an end user device. The web application comprises a sensing module comprising computer readable instructions configured to be executed by a processor of the end user device. On execution of the computer readable instructions, the processor is configured to collect one or more inputs from one or more sources in the end user device, communicate the collected one or more inputs to a centralized server, for example, a centralized server, a cloud based server, etc., comprising a peer software application.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, in an embodiment, various structural elements can be employed depending on the design choices of the system designer.

Other features and advantages of the inventive concepts will become apparent from the following description of the invention, which refers to the accompanying drawings.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a system comprising an end user device, a centralized server, a network, and multiple content provider servers.

FIG. 2 exemplarily illustrates a method of providing feedback to one of a 4G and a 5G network for requesting a particular quality of experience on an end user device connected to the network.

FIG. 3 exemplarily illustrates a method of providing feedback to a network for requesting a particular network slice on an end user device connected to the network.

FIG. 4 exemplarily illustrates inputs sensed, processed and provided to a server by one or more of a client application in an end user device, operating system of the end user device, a firmware in the end user device, and a web application in the end user device.

FIG. 5 exemplarily illustrates providing feedback to a 4G network for requesting a particular quality of experience on an end user device connected to the 4G network.

FIG. 6 exemplarily illustrates providing feedback to a 4G network comprising a virtual Evolved Packet Core (EPC) for requesting a particular quality of experience on an end user device connected to the network.

FIG. 7 exemplarily illustrates providing feedback to a 5G network for requesting a particular network slice on an end user device connected to the network.

### DETAILED DESCRIPTION OF THE PREFERRED EMBODIMENTS

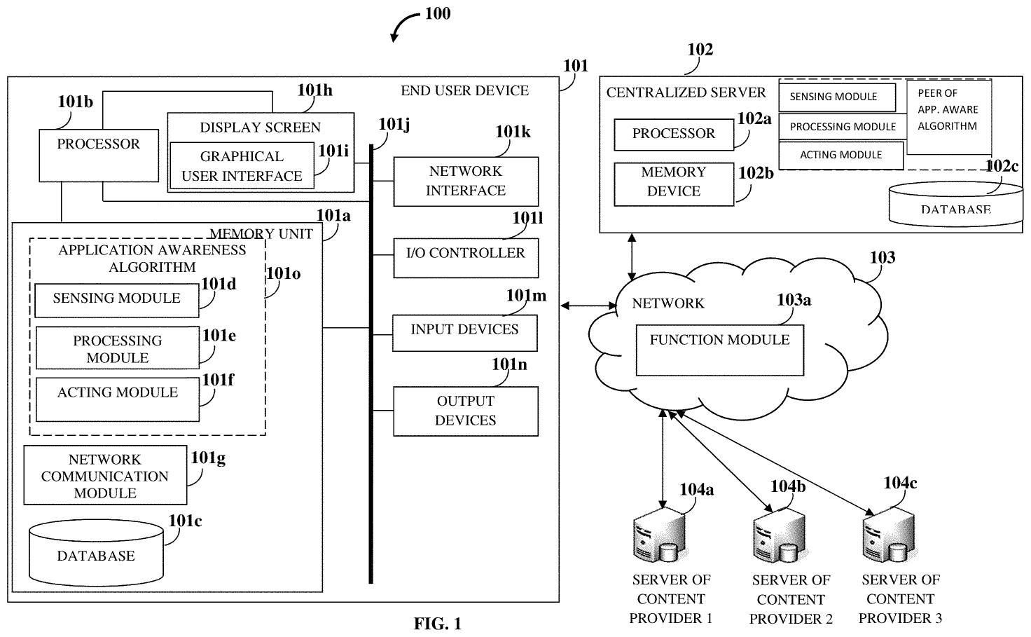

FIG. 1 exemplarily illustrates a system 100 comprising an end user device 101, a server 102, a network 103, and multiple content provider servers 104a, 104b and 104c. The end user device 101, the server 102, and the content provider servers 104a, 104b and 104c are connected to the network 103. As used herein, the end user device 101 is an electronic device capable of connecting to a cellular communication network. Examples of end user devices 101 comprise a smartphone, a handheld tablet computer, a mobile internet device, etc. In an embodiment, the end user device 101 is an internet device that connects to the internet through a wired medium using, for example, an Ethernet port of the internet device 101. Also as used herein, the network 103 refers to a cellular communication network comprising a 3G network, 4G network, a 5G network, etc. In an embodiment, the network is a wired communication network comprising a telephone network, cable internet, fiber optics network, etc. The end user device comprises a memory unit 101a, a processor 101b operably coupled to the memory unit 101a, and a client application comprising computer readable instructions of an application awareness algorithm 1010 stored in the memory unit 101a. The computer readable instructions are configured to be executed by the processor 101b of the end user device 101. The computer readable instructions in the application awareness algorithm 1010 correspond to a sensing module 101d, a processing module 101e, and an acting module 101f. In an embodiment, the computer readable instructions when executed by the processor 101b provide the sensing module 101d, the processing module 101e, and the acting module 101f. When the computer readable instructions are executed by the processor 101b of the end user device 101, the software instructions cause the processor 101b to sense inputs from one or more sources in the end user device 101 using the sensing module 101d. The sources comprise one or more points in the network, software applications, for example, internet applications running on the end user device 101, one or more software integrated in an operating system of the end user device 101, and firmware integrated in the processor 101b of the end user device 101.

Examples of points in the network comprise User Equipment, for example, end user devices; eNode-Bs/gNBs; P-GWs; Authentication Servers; Dynamic Host Configuration Protocol (DHCP) servers; Network Address Translation (NAT) equipment; Network Intelligence equipment; and interfaces to Content Distribution Network (CDN) or Content Provider Networks. gNBs are a set of radio base stations connected to the 5G core network (5GC) and to each other. eNode-B, also known as E-UTRAN Node B, also known as Evolved Node B (abbreviated as eNodeB or eNB), is the element in E-UTRA of LTE that is the evolution of the element Node B in UTRA of UMTS. It is the hardware that is connected to the mobile phone network that communicates directly wirelessly with mobile handsets (UEs), like a base transceiver station (BTS) in GSM networks. A P-GW (Packet Data Network Gateway serves as an ingress and egress point to the Evolved Packet Core (EPC) from a PDN (Packet Data Network) such as the Internet. When a subscriber establishes an EPS (Evolved Packet System) bearer to a given PDN, the P-GW serves as the point of attachment to that PDN for the life of the EPS bearer (regardless of any mobility procedures).

Examples of software applications running on the end user device 101 comprise the client application running on end user device 101 that improves Quality of Experience (QoE) to users of the end user device 101, a video streaming application, an audio streaming application, a banking application, etc. The software integrated in the operating system of the end user device 101 comprises one or more features of the client application, etc. Therefore, the software integrated in the operating system of the end user device 101 is already part of the end user device 101, and a separate software application need not be downloaded on the end user device 101. The software integrated in the operating system of the end user device 101 is a “lightweight” application.

As used herein, the processor 101b refers to the main processor of the end user device, a network processor of the end user device, a SoC (System on Chip) of the end user device 101.

In an embodiment, an end user device 101 connected to one of a 4G and a 5G network 103 is provided. As explained earlier, the end user device 101 comprises the memory unit 101a, the processor 101b operably coupled to the memory unit 101a, and the client application comprising computer readable instructions of the application awareness algorithm 101o stored in the memory unit 101a of the end user device 101. The computer readable instructions when executed by the processor 101b cause the processor 101b to sense, using the sensing module 101d, inputs from the one or more sources. The computer readable instructions further cause the processor 101b to process, using the processing module 101e, the sensed inputs to determine one or more changes in parameters of the network 103 for providing a particular quality of experience (QoE) by the network 103 to a user of the end user device 101. The computer readable instructions further cause the processor 101b to provide, using an acting module 101f, the determined changes as feedback to the server 102 connected to the network 103. The server 102 is configured to effect the one or more determined changes in the parameters of the network 103 for providing the particular quality of experience (QoE). In an embodiment, the acting module 101f correspondingly obtains or receives instructions from the server 102, in response to the feedback provided to the server 102.

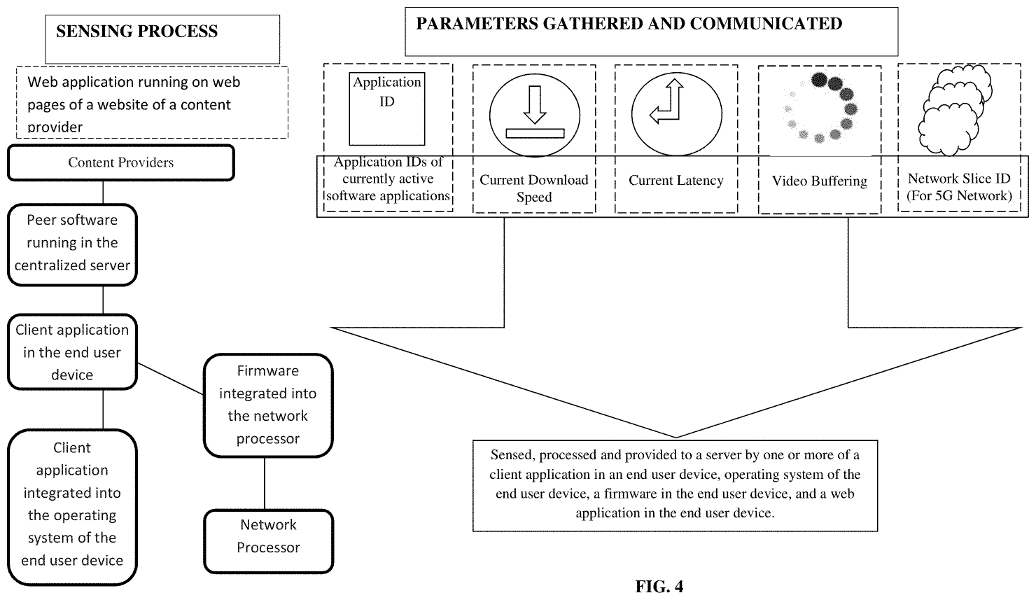

FIG. 4 exemplarily illustrates inputs sensed by the sensing module, processed by the processing module, and provided to the server 102 by the acting module in the end user device 101. In an embodiment, the inputs from one or more sources in the end user device 101 is sensed by either the operating system of the end user device 101, a firmware in the end user device 101, and a web application in the end user device 101. The inputs sensed by the sensing component of the client application or the firmware in the end user device 101 (running in the SoC) is related to the QoS—like currently available bandwidth, latency and details of any video buffering (where applicable), etc.

In case of a 5G network or a 4G network, the sensed inputs comprise one or more of a bit rate and bandwidth provided by the network to determine if the requirements of the end user device for one or more of a minimum bit rate and a guaranteed bit rate are being met. The sensed inputs also comprise latency provided by the network to the end user device 101. The sensed inputs also comprise one or more of a bit error rate and a packet error rate, as a part of Quality of Service (QoS) Class identifier (QCI). The sensed inputs also comprise throughput provided by the network to the end user device. In an embodiment, the module is configured to measure the one or more sensed inputs. The measured inputs are recorded in a database 101c. In an embodiment, the measured inputs are used to determine if the requirements of the client application, a software application, and/or the end user device 101 are being met. In an embodiment, the software application running on the end user device 101 is specifically built to detect download speed provided by the network, current latency, bandwidth, video buffering, etc. In an embodiment, the client application comprising computer readable instructions of the application awareness algorithm is configured to detect download speed provided by the network, current latency, bandwidth, video buffering, etc.

In an embodiment, in case of a 4G network, the inputs sensed by the sensing module further comprise gaming parameters comprising load time and API latency by interacting with a gaming application on the end user device. Furthermore, the inputs sensed by the sensing module further comprise video parameters comprising video start time, video end time, bandwidth required by the video, buffering durations and number of bufferings in a specific interval, video resolution, time when a video was paused, time when a video was resumed, and video genre by interacting with a software application that is playing the video on the end user device 101. The inputs sensed by the sensing module also comprise identifying software applications running on the end user device by interacting with the operating system of the end user device to obtain identifiers of software applications. The sensing module also senses an IP address of the end user device 101, and wherein the application awareness algorithm is further configured to associate the sensed IP address to a Mobile Subscriber International Subscriber Directory Number (MSISDN) of the user. The sensing module also senses parameters of the end user device 101 comprising the operating system on the end user device, version of the operating system, display parameters of the end user device, and the memory parameters of the end user device.

In an embodiment, in case of a 5G network or a 4G network, the application awareness algorithm is further configured to interact, using the sensing module, with a Policy Charging and Rules Function (PCRF) and sense the plans and subscriptions of a user to provide relevant information to a Complex Rules Engine as part of processing the sensed inputs. The application awareness algorithm is also configured to interact, using the sensing module, with a peer software application running in a cloud server (centralized server), to obtain additional information regarding one or more of the sensed inputs, parameters of the end user device, and historical information.

In case of a 5G network, the inputs sensed by the sensing module further comprise gaming parameters comprising load time and API latency by interacting with a gaming application on the end user device. Furthermore, the inputs sensed by the sensing module further comprise video parameters comprising video start time, video end time, bandwidth required by the video, buffering durations and number of bufferings in a specific interval, video resolution, time when a video was paused, time when a video was resumed, and video genre by interacting with a software application that is playing the video on the end user device 101. The inputs sensed by the sensing module also comprise identifying software applications running on the end user device by interacting with the operating system of the end user device to obtain identifiers of software applications. The application identifiers, for example, Application IDs, are identifiers of one or more software applications running on the end user device 101. In an embodiment, in case of the 5G network, Network Slice ID is also identified. Network Slice ID is an identifier of the particular network slice. In an embodiment, the Network Slice ID comprises both default Network Slice Selection Assistance Information (NSSAI) and mapping of the Application ID to the NSSAI. The NSSAI informs the Network which slice the Network has to give in 5G. Thus, the Application ID is sensed by the “Sensing” module 101d and on the basis of that, a specific Network Slice is requested from the Network 103 by the “Acting” module 101f. Usually, the end user device 101, for example, a mobile device, comprises a default NSSAI. However, the default NSSAI can be changed any time by the network for various reasons. In an embodiment, the network informs the application awareness algorithm 1010 regarding the change in the default NSSAI. The application awareness algorithm 1010 informs the change in the default NSSAI to the software application running on the end user device 101 to enable the software application to be aware of the network slice it will receive based on the change in the default NSSAI. The Application ID indicates a specific software application running on a mobile which would, because of the software application's characteristics, require a specific network slice only, and that has to be provided by the network. For instance, a video streaming application would be in need of a high bandwidth and therefore, for example, the video streaming application is allotted Slice ‘K’. Another software application running on the same end user device 101 would require only a “Best Effort” slice, and it could be allotted Slice ‘M’, a “default slice”. In an embodiment, each end user device 101 could simultaneously obtain 8 different slices, for example, for 8 different software applications running on the end user device 101. The software applications running on the end user device 101 comprise software applications that are running in the background and software applications that are running in the foreground.

The software instructions further cause the processor 101b to process the sensed inputs using the processing module 101e to determine one or more changes in parameters of the network 103. In case of a 4G network, the processing module 101e determines one or more changes in the parameters of the network 103 for providing a particular quality of experience (QoE) by the network 103 to a user of the end user device 101. The software instructions further cause the processor 101b to provide, using the acting module 101f, the determined changes as feedback to a server 102 connected to the network 103. In response to receiving the determined changes as feedback from the end user device 101, the server 102 effects the one or more determined changes in the parameters of the network 103 for providing the particular quality of experience.

In the case of a 5G network, the processing module 101e determines one or more changes in the parameters of the network 103 for providing a particular network slice by the network 103 to a software application running on the end user device 101. The software instructions further cause the processor 101b to provide, using the acting module 101f, the determined changes as feedback to the server 102 connected to the network 103. In response to receiving the determined changes as feedback from the end user device 101, the server 102 effects the one or more determined changes in the parameters of the network 103 for providing the particular network slice.

In an embodiment, the processing module 101e processes the sensed inputs based on the rules the processing module 101e receives from a peer software running on the server 102 (the centralized server or cloud). Alternatively, the processing module 101e performs minimal processing of the sensed inputs and allows the acting module 101f to complete the remaining processing. For example, the processing module 101e determines the required bandwidth, latency, and/or such parameters that require modification in order to improve the QoE required for the software application(s) running on the end user device in case of a 4G network, or the network slice required to be requested from network 103 in case of a 5G network.

In an embodiment, the sensed inputs and parameters of the end user device 101 are processed in a cloud server 102, for example a centralized server, along with Business logic, subscriber SLA and other relevant subscriber information of the user obtained from one or more of the content provider (104a, 104b and 104c), telecom operator, a complex rules engine in order to enable the acting module 101f to provide the determined changes as feedback to a server 102 connected to the network. The acting module 101f correspondingly obtains or receives instructions from the server 102, in response to the feedback provided to the server 102.

The server 102, illustrated in FIG. 1, for example, is a centralized server, a cloud based server, etc., connected to an end user device 101 through the network 103. The server 102 effects the one or more predetermined changes in the parameters of the network 103 by providing a feedback to the network 103. The server 102 interfaces with a Policy Charging and Rules Function (PCRF) of the network 103 to provide feedback. The PCRF in-turn instructs an Evolved Packet Core (EPC) of the 4G network 103 to provide the appropriate resources to the one or more software applications running on the end user device 101. EPC is a framework for providing converged voice and data on a 4G Long-Term Evolution (LTE)network. 2G and 3G network architectures process and switch voice and data through two separate sub-domains i.e., circuit-switched (CS) for voice and packet-switched (PS) for data. Whereas, the EPC unifies voice and data on an Internet Protocol (IP) service architecture and voice is treated as just another Internet Protocol (IP) application. This allows operators to deploy and operate one packet network for 2G, 3G, WLAN, WiMAX, LTE and fixed access (Ethernet, DSL, cable and fiber).

In a 5G network, a Policy Control Function (PCF) performs the same function as the PCRF in a 4G network. For example, PCF provides policy rules for control plane functions. This includes network slicing, roaming and mobility management. The PCF accesses subscription information for policy decisions taken by the UDR. The PCF also supports the 5G QoS policy and charging control functions.

In a 4G network, the changes in the parameters of the network for providing the particular quality of experience (QoE) comprise changes to bandwidth provided by the network, latency provided by the network, throughput provided by the network, and bit rate provided by the network.

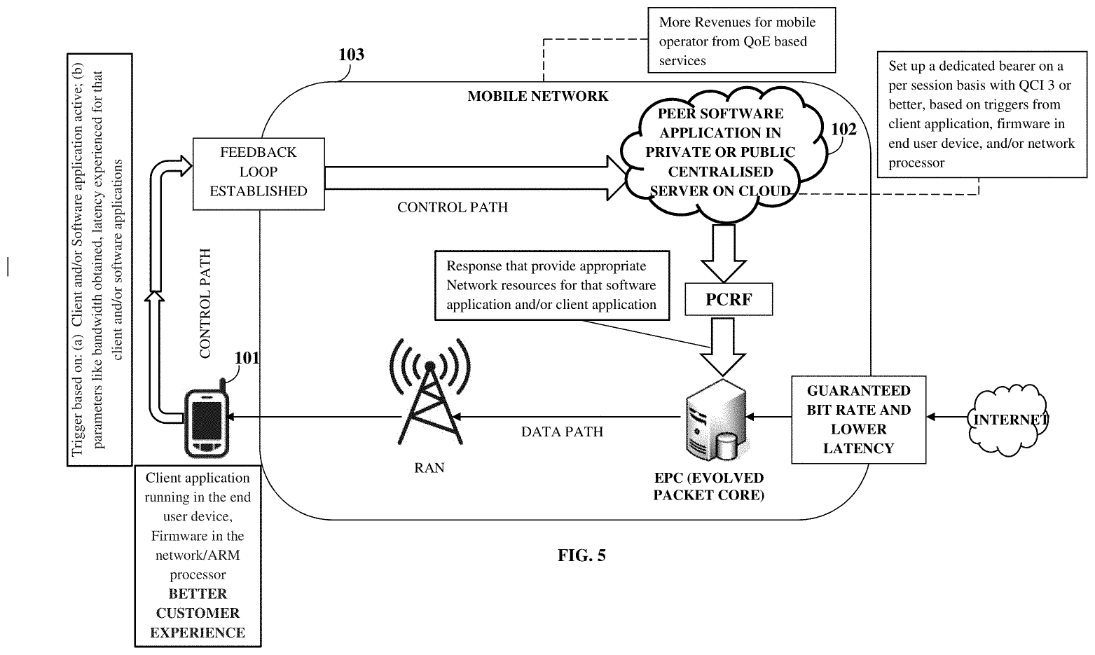

FIG. 5 exemplarily illustrates providing feedback to a 4G network 103 for requesting a particular quality of experience on an end user device 101 connected to the 4G network 103. The application awareness algorithm 1010 stored in the memory device 101a of the end user device 101 is triggered based on the software application that is active or currently running on the end user device 101. In an embodiment, the application awareness algorithm 1010 in the end user device 101 is also triggered based on the parameters comprising current download speed, current latency experienced by the software application, bandwidth obtained by the software application from the network 103, details of video buffering, etc. By providing the requested particular quality of experience by the network 103 to a software application on the end user device 101 (by providing the appropriate network resources to the software application), it is possible to enable the user have a better usage experience. In an embodiment, the feature of requesting a particular quality of experience from a network 103 by an end user device 101 is used by a service provider to generate additional revenue. For example, a user is billed when a software application in the end user device 101 of the user requests a particular quality of experience from the network 103. In an embodiment, as illustrated in FIG. 5, the network path between the end user device 101 and the server 102, between the server 102 and the PCRF, and between the PCRF and the EPC may be called the control path since this is the path through which a request for the particular quality of experience is placed with the network 103. On the other hand, the path between the EPC, the Radio access network (RAN) and the end user device 101 may be called the data path since the EPC ensures that the requested download speed, latency, and bandwidth are provided to the software application on the end user device 101. In an embodiment, the server 102 sets up a dedicated bearer on a per session basis with QCI 3 (QoS Class Identifier 3) or better, based on triggers from one or more of the client application comprising the application awareness algorithm, firmware running in the end user device 101, the processor 101b executing the computer readable instructions stored in a memory unit of the end user device 101.

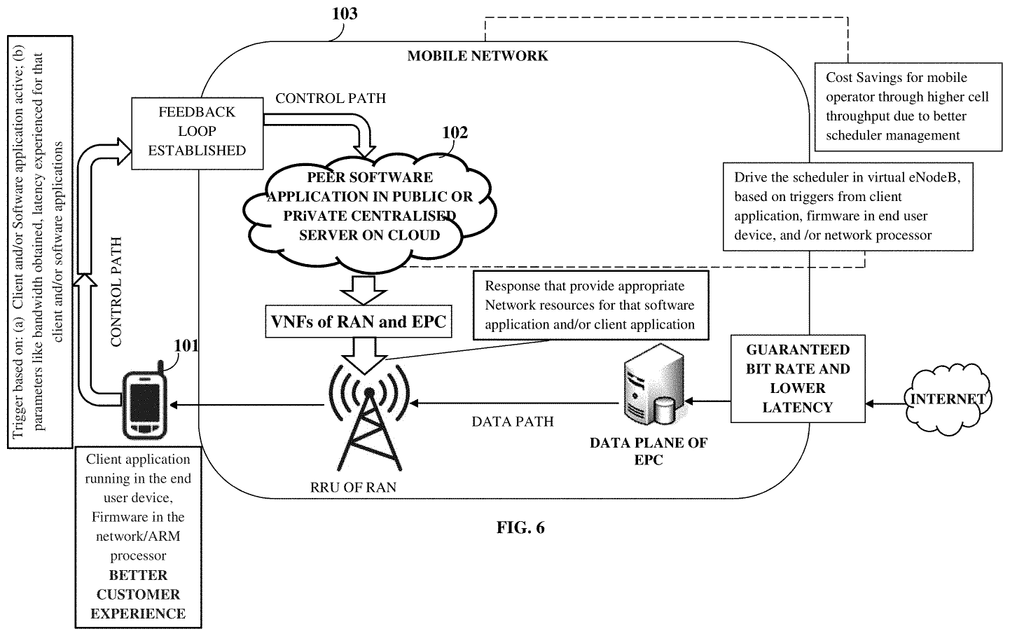

FIG. 6 exemplarily illustrates providing feedback to a 4G network 103 comprising a Virtual Evolved Packet Core (vEPC) for requesting a particular quality of experience on an end user device 101 connected to the network 103. In a regular 4G network, Mobility Management Entity (MME), Serving Gateway (S-GW), and Packet Data Network Gateway (P-GW) are each implemented using a different hardware. For example, the MME, S-GW and P-GW may have their own specific hardware. A vEPC is a framework for voice and data processing and switching for mobile networks that is implemented by Network Functions Virtualization (NFV), which virtualizes the functions of an Evolved Packet Core (EPC). A NFV is a network architecture concept that uses the technologies of Information Technology (IT) virtualization to virtualize entire classes of network node functions into building blocks that may connect, or chain together, to create communication services. Furthermore, a vEPC would be orchestrated and only when processing is required, would the virtual entities of the network elements, for example, hub, switch, router, etc., be spawned. As illustrated in FIG. 6, the network path between the end user device 101 and the server 102, between the server 102 and the (Virtual Network Functions) VNFs of RAN and EPC, between the VNFs of RAN and EPC and the RRU of RAN, and between RRU of RAN and the end user device 101 is called the control path since this is the path through which a request for the particular quality of experience is placed with the network 103. On the other hand, the path between the end user device 101, the RRU of RAN, Data plane of EPC and Internet is called the data path since the EPC ensures that the requested download speed, latency, bandwidth and other network resource are provided to the software application on the end user device 101. Here, the trigger to request for a network resource is based on the type of software application that is active and running on the end user device 101, and also based on parameters like bandwidth obtained, latency experienced by that software application, etc. In an embodiment, the server 102 drives a scheduler in virtual eNodeB, based on triggers from one or more of the client application comprising the application awareness algorithm, software applications running either standalone, or integrated with the OS or with firmware running in the end user device 101, the processor 101b executing the computer readable instructions stored in a memory unit of the end user device 101. The mobile operator can save cost through higher cell throughput due to better scheduler management.

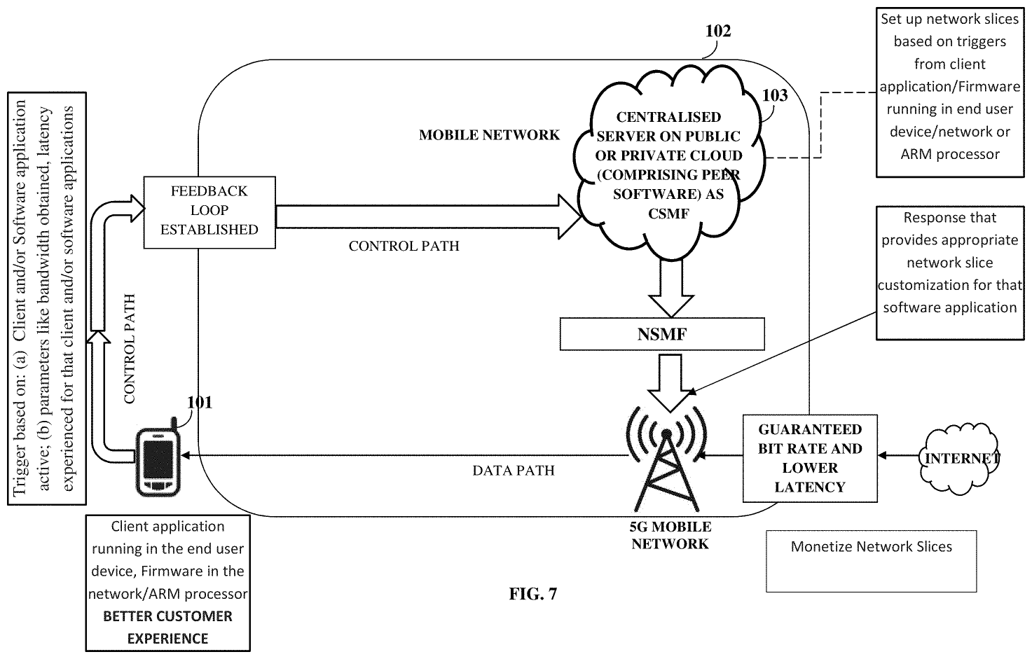

FIG. 7 exemplarily illustrates providing feedback to a 5G network 103 for requesting a particular network slice on an end user device 101 connected to the network 103. Instead of determining changes in the parameters of the network 103 for providing the particular quality of experience, the end user device 101 determines one or more changes in the parameters of the network 103 for providing a particular network slice by the network 103. The end user device 101 provides the determined changes as feedback to the server 102 connected to the network 103. In response to receiving the determined changes as feedback from the end user device 101, the server 102 is configured to effect the one or more determined changes in the parameters of the network 103 for providing the particular network slice. The server 102 effects the one or more predetermined changes in the parameters of the network 103 by providing a feedback to the network 103. In a 5G network 103, the server 102 interfaces with a Communication Service Management Function (CSMF) or a Network Slice Management Function (NSMF) of the 5G network 103 to provide feedback. The CSMF or the NSMF in-turn instructs the 5G network 103 to provide the particular network slice suitable for the particular service or the software application running on the end user device, using which the user may obtain a good quality of experience. The process of providing the requested network slice by the network 103 to the particular service or the software application on the end user device 101 provides a better usage experience to the user. In an embodiment, the feature of requesting a particular network slice from a network 103 by an end user device 101 may be used by a service provider to generate additional revenue. For example, a user may be billed when a software application in the end user device 101 or a particular service requests a network slice from the network 103. In an embodiment, the determined changes communicated by the acting module 101f to the server 102 comprise a request to a Network Slice Management Function (NSMF) of the network 103 to request for a specific network slice for a software application. The network slice is one of a maximum of eight slices which are simultaneously accessible by the end user device 101. As illustrated in FIG. 7, the network path between the end user device 101 and the server 102, and between the server 102 and the Network Slice Management Function (NSMF) is called the control path since this is the path through which a request for the particular network slice is placed with the network 103. On the other hand, the path between the end user device 101, the 5G mobile network and the Internet is called the data path since the NSMF ensures that the requested network slice is provided to the software application on the end user device 101. Here, the trigger to request for one or more network slices is based on the type of software application that is active and running on the end user device 101, and also based on parameters like bandwidth obtained, latency experienced by that software application, etc. The server sets up network slices based on the triggers from one or more of the client application comprising the application awareness algorithm, software applications running either standalone, or integrated with the OS or firmware running in the end user device 101, the processor 101b executing the computer readable instructions stored in a memory unit of the end user device 101.

In an embodiment, for a 5G network, the acting module communicates the determined changes to the server. The determined changes comprise a request to a Network Slice Management Function (NSMF) of the network to request for a specific network slice for a software application. Here, the network slice is one of a maximum of eight slices which are simultaneously accessible by the end user device. The determined changes also comprise a specific Guaranteed Bit Rate (GBR) in a 5G network; a specific Quality of Service for the 5G network (5QI) to assure a predetermined latency for the requirement of the one or more software applications; and a specific delay-critical bearer.

In an embodiment, for a 5G network, an Application Function utilizes the sensing module and the processing module to change User Equipment Route Selection Policies (URSP) rules in the end user device 101 which associate the software applications and/or traffic types, to specific network slices, dynamically in real-time, via a Policy and Charging Control Framework (PCF).

In an embodiment, the inputs sensed also comprise information of whether the user has paid applicable bills for using one or more of the network 103, the end user device 101, the feature of requesting a particular network slice, and the feature of requesting a particular quality of experience. In an embodiment, the inputs sensed also comprise information about the end user device 101, information of bills paid in the past, and usage histories of the features of requesting a particular network slice and requesting a particular quality of experience. In an embodiment, the inputs sensed also comprise information about frequently used software applications, usage pattern of the software applications and the end user device 101, and time of day of usage for the end user device 101. In an embodiment, the sensing module 101d is configured to interact with the PCRF (Policy Charging and Rules Function) and senses the plans and subscriptions of the user so as to provide the relevant information to a Rules Engine. In an embodiment, the sensing module 101d is configured to sense the end user device 101 parameters such as the operating system of the end user device 101 and the version of the operating system running in the end user device 101, parameters such as the, the display parameters and the memory parameters of the end user device 101. In an embodiment, the sensing module 101d is configured to interact with the server 102, or for example, a peer software application running in the server, a software application running in the server, etc., to obtain additional information regarding the sensed inputs and/or historical information. The additional information regarding the sensed inputs and/or historical information is stored in a cloud server.

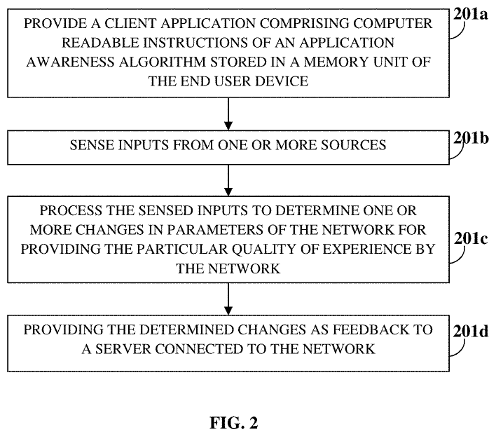

FIG. 2 exemplarily illustrates a method of providing feedback to a network 103 for requesting a particular quality of experience (QoE) on an end user device 101 connected to the network 103. The method comprises providing 201a an application awareness algorithm comprising computer readable instructions stored in a memory unit 101a of the end user device 101. When the computer readable instructions are executed by a processor 101b of the end user device 101, the processor 101b performs steps comprising sensing 201b inputs from one or more sources in the end user device 101, processing 201c the sensed inputs to determine one or more changes in parameters of the network 103 for providing the particular quality of experience by the network 103, and providing 201d the determined changes as feedback to a server 102 connected to the network 103. The one or more sources comprise one or more points in the network, one or more software applications running on the end user device 101, one or more software integrated in an operating system of the end user device 101, and firmware integrated in the processor 101b of the end user device 101. The server 102 is configured to effect the one or more determined changes in the parameters of the network 103 for providing the particular quality of experience (QoE).

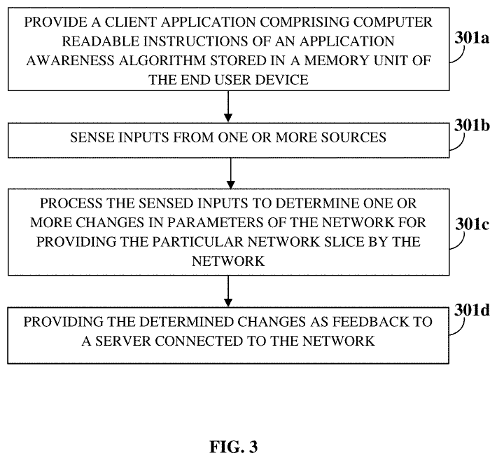

FIG. 3 exemplarily illustrates a method of providing feedback to a network 103 for requesting a particular network slice on an end user device 101 connected to the network 103. The method comprises providing 301a an application awareness algorithm comprising computer readable instructions stored in a memory unit 101a of the end user device 101. When the computer readable instructions are executed by a processor 101b of the end user device 101, the processor 101b performs steps comprising sensing 301b inputs from one or more sources in the end user device 101, processing 301c the sensed inputs to determine one or more changes in parameters of the network 103 for providing 301c a particular network slice by the network 103. The method further comprises providing 301d the determined changes as feedback to a server 102 connected to the network 103. The server 102 is configured to effect the one or more determined changes in the parameters of the network 103 for providing the particular network slice.

In an embodiment, the sensing module 101d is configured to sense an IP address of the end user device 101 and associates an IP address to the Mobile Subscriber International Subscriber Directory Number (MSISDN) of the user.

Also disclosed herein is an end user device 101 operating system architecture for providing feedback to a network 103. The operating system comprises computer readable instructions stored in a memory unit 101a of the end user device 101. The computer readable instructions are configured to be executed by a processor 101b of the end user device 101. When the computer readable instructions are executed by the processor 101b, they cause the processor 101b to sense inputs from one or more software applications running on the end user device 101, and provide the sensed inputs as feedback to a server 102 connected to the network 103. The server 102 is configured to effect one or more changes in the parameters of the network 103. The changes effected in the parameters of the network cause the network to either provide a particular quality of experience to a user of the end user device 101, or provide a particular network slice to a software application running on the end user device 101. In an embodiment, the end user device 101 operating system architecture comprises a sensing module 101d integrated into the operating system. The sensing module 101d senses the inputs from the one or more software applications running on the end user device 101. The inputs sensed by the sensing module 101d comprise a bit rate and/or bandwidth provided by the network to determine if the requirements of the end user device for one or more of a minimum bit rate and a guaranteed bit rate are being met. The inputs sensed by the sensing module 101d also comprise latency provided by the network to the end user device; gaming parameters comprising load time and API latency that are obtained by interacting with a gaming application on the end user device; a bit error rate and/or a packet error rate, as a part of Quality of Service (QoS) Class identifier (QCI); video parameters comprising video start time, video end time, bandwidth required by the video, buffering durations and number of bufferings in a specific interval, video resolution, time when a video was paused, time when a video was resumed, and video genre by interacting with a software application that is playing the video on the end user device; and throughput provided by the network to the end user device.

In the end user device 101 operating system architecture described above, the feedback provided to the server comprises a request to effect one or more changes in the parameters of the network for providing a particular quality of experience (QoE) to the one or more software applications running on the end user device 101. In another embodiment, the feedback provided to the server comprises a request to effect one or more changes in the parameters of the network for providing a particular network slice to the one or more software applications running on the end user device. In an embodiment, vendors of the processor 101b and/or the operating system of the end user device 101 allow client application to interact with the operating system of the end user device 101 via APIs.

In an embodiment, an end user device 101 connected to a network 101 is provided. The end user device 101 comprises a memory unit 101a and a processor 101b. The processor 101b is for example, a network processor. The memory unit 101a is operably coupled to the processor 101b. The memory unit 101a comprises computer readable instructions that when executed by the processor cause the processor to sense inputs from one or more of a plurality of software applications running on the end user device 101, and provide the sensed inputs to a server 102 connected to the network. In an embodiment, the computer readable instructions correspond to the client application of an application awareness algorithm. In another embodiment, the computer readable instructions correspond to a firmware stored in the memory unit 101a. The server 102 is configured to effect one or more changes in the parameters of the network 103. The changes in the parameters of the network 103 enable to network 103 to provide either a particular quality of experience to a user of the end user device 101. In an embodiment, the changes in the parameters of the network 103 enable to network 103 to provide a particular network slice to a software application running on the end user device 101. Generally, the processor 101b of the end user device 101 comprises a set of Digital Signal Processors (DSPs) and an ARM processor, for example, a Network processor. In an embodiment, the processor 101b of the end user device 101 is a main processor of the end user device 101. The firmware is configured to run on the Network Processor or the main processor. In an embodiment, the firmware and the processor 101b and/or the operating system of the end user device 101 are programmed to interact with each other using Application Programming Interfaces (APIs). In an embodiment, vendors of the processor 101b and/or the operating system of the end user device 101 allow the processor executing the computer readable instructions to interact with the operating system of the end user device 101 via APIs. In an embodiment, vendors of the processor 101b and/or the operating system of the end user device 101 allow client application to interact with the operating system of the end user device 101 via APIs.

The end user device 101 connected to the network, as disclosed above, further comprises a sensing module. The sensing module senses the inputs from the one or more software applications running on the end user device 101. The inputs comprise a bit rate and/or bandwidth provided by the network to determine if the requirements of the end user device for one or more of a minimum bit rate and a guaranteed bit rate are being met. The inputs also comprise latency provided by the network to the end user device; video parameters of a video game application by interacting with a video game application on the end user device, when the processor is processing the video game; a bit error rate and/or a packet error rate, as a part of Quality of Service (QoS) Class identifier (QCI); and throughput provided by the network to the end user device. The inputs also comprise video parameters comprising video start time, video end time, bandwidth required by the video, buffering durations and number of bufferings in a specific interval, video resolution, time when a video was paused, time when a video was resumed, and video genre by interacting with a software application that is playing the video on the end user device and when the processor is processing the video.

Also disclosed herein is a server 102, for example, a centralized server, a cloud based server, etc., connected to an end user device 101 through a network 103. The server 102 comprises a memory device 102b, a processor 102a operably coupled to the memory device, and a peer software application stored in the memory device 102b. In an embodiment, the peer software application is, for example, a server component of the application awareness algorithm in the end user device 101. The peer software application comprises computer readable instructions configured to be executed by the processor 102a. The computer readable instructions, on execution by the processor 102a, cause the processor 102a to receive inputs from one or more software applications each residing on an end user device 101. Here, the inputs correspond to one or more changes in parameters of the network 103. The computer readable instructions also cause the processor 102a to process the received inputs in a rules engine to determine one or more changes in parameters of the network 103 for the one or more end user devices 101 comprising the software application. The rules engine comprises rules that help in processing the received inputs to determine the changes in the parameters of the network 103. The rules engine could be of various types—for example, users who require higher bandwidth can be provided the same if one or more conditions are met. For example, if the user of the end user device 101 is a “golden” user or a “platinum” user, which can be obtained from a Subscriber Profile Registry (SPR), the user is provided with the requested higher bandwidth. In one embodiment, at certain Time of Day (TOD), these conditions could be waived off. In another embodiment, at the certain Time of Day (TOD), these conditions are not waived off. In another embodiment, higher bandwidth can be provided only for certain eNode-Bs. The rules in the rules engine can be provided by the network operator and the network operator may also implement the rules. The network operator may also modify the rules in real time. The rules may be stored in a database and the operator may access the database to implement different rules for different scenarios in real- time. The computer readable instructions also cause the processor 102a to interface with a function module 103a of the network 103 and communicate the determined changes to the function module 103a. The function module 103a is, for example, a Communication Service Management Function (CSMF) or a Network Slice Management Function (NSMF) of the 5G network 103. In case of a 4G network, the function module 103a is a Policy Charging and Rules Function (PCRF). The network 103 is for example, a 4G network, a 5G Network, etc. If the network 103 is a 4G network, the function module 103a effects changes in the parameters of the network 103 to improve Quality of Experience (QoE) for a specific end user device. If the network 103 is a 5G network, the function module 103a effects changes in the parameters of the network 103 to and provide a required network slice to a specific software application used by the one or more end user devices 101.

In an embodiment, the peer software application on the server 102 comprises a sensing module to receive inputs from the one or more software applications residing on the end user device 101, a processing module to process the received inputs in the rules engine, and an acting module to interface with the function module 103a of the network 103 and communicate the determined changes to the function module 103a. In an embodiment, rules in the rules engine are defined by the operator of the network 103 and the rules are dynamically modifiable. The rules are stored in a database 102c as shown in FIG. 1. The sensing module does the function of collecting inputs from (a) the end user devices 101 that run the client application, (b) the end user device 101 operating system architecture, and (c) the end user device 101 having a network processor running a firmware of the client application. The processing module processes the information obtained in a rules engine and determines, based on rules defined by the operator (which are dynamically modified), parameters of the network 103 for improved QoE for the specific end user device 101 and/or the specific software application (streamed video, video conferencing, gaming, self-driven vehicles, etc.). The acting module, in case of 4G networks, would interface with a Policy Charging and Rules Function (PCRF) to make the needed modifications to the Network. In the case of 5G networks, the acting module would interface with a CSMF (Communication Service Management Function) or an NSMF (Network Slice Management Function) whereby the specific service for the specific user is given the Slice of the 5G Network it actually requires to obtain a good quality of experience.

Also disclosed herein is a web application configured to be downloaded on an end user device 101. The web application comprises a sensing module comprising computer readable instructions configured to be executed by a processor 101b of the end user device 101. The web application is, for example, a script running on a web page of a website of a content provider server 104a, 104b, or 104c. Examples of content providers comprise Google, Netflix, LinkedIn, YouTube, Uber, Facebook, Amazon, etc. When a user of the end user device accesses the website of the content provider and wants to obtain the services of the content providers, the web application gets loaded on to the end user device along with the web page. On execution of the computer readable instructions, the processor 101b is configured to collect one or more inputs from one or more sources in the end user device 101, communicate the collected one or more inputs to a server 102, for example, a centralized server, a cloud based server, etc., comprising a peer software application. The collected one or more inputs from one or more sources in the end user device comprise one or more of a bit rate and bandwidth provided by the network to determine if the requirements of the end user device for one or more of a minimum bit rate and a guaranteed bit rate are being met; latency provided by the network to the end user device; one or more of a bit error rate and a packet error rate, as a part of Quality of Service (QoS) Class identifier (QCI); and throughput provided by the network to the end user device.

In an embodiment, upon receiving the inputs from the end user device 101, the server 102 is configured to effect one or more changes in the parameters of the network for providing a particular quality of experience (QoE) to a user of the end user device 101. The changes in the parameters of the network for providing the particular quality of experience (QoE) comprise changes to bandwidth provided by the network, latency provided by the network, throughput provided by the network, and bit rate provided by the network. The changes in the parameters of the network for providing the particular quality of experience (QoE) further comprise a specific Guaranteed Bit Rate (GBR) in a 5G network; a specific Quality of Service for the 5G network (5QI) to assure a predetermined latency for the requirement of the one or more software applications; and a specific delay-critical bearer.

The solution presented here could be applied to a wide variety of software applications like video, gaming and even self-driven vehicles (V2X communication) that use 5G networks. For example, in addition to the parameters indicated above, the signal strength and quality could also be read at the Mobile level and can be useful as inputs for algorithms involving self-driven vehicles. In another embodiment, parameters collected from unmanned drones (which are connected to a mobile network) could even additionally have aerial reconnaissance photographs. The quality required of those photographs would be dependent on the type of the peer software running in the cloud server. Therefore, only the parameters to be monitored and reported would be different for the various use cases. However, the solution presented herein can be used to implement specific customized solutions. In an embodiment, the peer software utilizes Artificial Intelligence (AI) to learn and take decision on the QoE or the network slice that can be provided to the end user device 101.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the methods and the systems disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the methods and the systems disclosed herein are implemented as programmed elements, or non-programmed elements, or any suitable combination thereof

Where databases are described such as the databases 101c and 102c, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the system 100, the databases are integrated to communicate with each other for enabling simultaneous updates of data linked across the databases, when there are any updates to the data in one of the databases.

The methods and the systems disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The methods and the systems disclosed herein are not limited to a particular computer system platform, processor, operating system, or network. In an embodiment, one or more aspects of the methods and the systems disclosed herein are distributed among one or more computer systems, for example, servers configured to provide one or more services to one or more client computers, or to perform a complete task in a distributed system. For example, one or more aspects of the methods and the systems disclosed herein are performed on a client-server system that comprises components distributed among one or more server systems that perform multiple functions according to various embodiments. These components comprise, for example, executable, intermediate, or interpreted code, which communicate over a network using a communication protocol. The methods and the systems disclosed herein are not limited to be executable on any particular system or group of systems, and are not limited to any particular distributed architecture, network, or communication protocol.

What is claimed as new and desired to be protected by Letters Patent of the United States is:

1. An end user device connected to one of a 4G and a 5G network, the end user device comprising:
a memory unit;
a processor operably coupled to the memory unit; and
a client application comprising computer readable instructions of an application awareness algorithm stored in the memory unit of the end user device, wherein the computer readable instructions when executed by the processor of the end user device cause the processor to:
sense, using a sensing module, inputs from one or more sources, wherein the sources comprise one or more points in the network, one or more of a plurality of software applications running on the end user device, one or more software integrated in an operating system of the end user device, and firmware integrated in the processor of the end user device;
process, using a processing module, the sensed inputs to determine one or more changes in parameters of the network for providing a particular quality of experience (QoE) by the network to a user of the end user device; and
provide, using an acting module, the determined changes as feedback to a server connected to the network, wherein the server is configured to effect the one or more determined changes in the parameters of the network for providing the particular quality of experience (QoE).

2. The end user device of claim 1, wherein the sensed inputs comprise:
a) one or more of a bit rate and bandwidth provided by the network to determine if the requirements of the end user device for one or more of a minimum bit rate and a guaranteed bit rate are being met;
b) latency provided by the network to the end user device;
c) one or more of a bit error rate and a packet error rate, as a part of Quality of Service (QoS) Class identifier (QCI); and
d) throughput provided by the network to the end user device.

3. The end user device of claim 2, wherein the sensing module is configured to measure the one or more sensed inputs.

4. The end user device of claim 1, wherein the determined one or more changes in the parameters of the network for providing the particular quality of experience (QoE) comprise changes to bandwidth provided by the network, latency provided by the network, throughput provided by the network, and bit rate provided by the network.

5. The end user device of claim 1, wherein providing the particular quality of experience (QoE) is provided by the network to one or more of the one or more software applications running on the end user device.

6. The end user device of claim 1, wherein the sensing module is further configured to sense one or more of:
gaming parameters comprising load time and API latency by interacting with a gaming application on the end user device;
video parameters comprising video start time, video end time, bandwidth required by the video, buffering durations and number of bufferings in a specific interval, video resolution, time when a video was paused, time when a video was resumed, and video genre by interacting with a software application that is playing the video on the end user device;
the one or more of the plurality of software applications running on the end user device by interacting with the operating system of the end user device to obtain identifiers of the one or more of the plurality of software applications;
an IP address of the end user device, and wherein the client application is further configured to associate the sensed IP address to a Mobile Subscriber International Subscriber Directory Number (MSISDN) of the user; and
parameters of the end user device comprising the operating system on the end user device, version of the operating system, display parameters of the end user device, and the memory parameters of the end user device.

7. The end user device of claim 1, wherein the sensing module is further configured to sense one or more of:
a Policy Charging and Rules Function (PCRF) and sense the plans and subscriptions of a user to provide relevant information to a Complex Rules Engine as part of processing the sensed inputs; and
interact with a software application running in a cloud server, to obtain additional information regarding one or more of the sensed inputs, parameters of the end user device, and historical information.

8. The end user device of claim 1, wherein the sensed inputs and parameters of the end user device are processed in a cloud server along with Business logic, subscriber SLA and other relevant subscriber information of the user obtained from one or more of the content provider, telecom operator, a complex rules engine in order to enable the acting module to provide the determined changes as feedback to a server connected to the network.

9. A method of providing feedback to one of a 4G and a 5G network for requesting a particular quality of experience (QoE) on an end user device connected to the network, the method comprising:
providing a client application comprising computer readable instructions of an application awareness algorithm stored in a memory unit of the end user device, wherein the computer readable instructions when executed by a processor of the end user device, cause the processor to perform steps comprising:
sensing inputs from one or more sources, wherein the sources comprise one or more points in the network, one or more of a plurality of software applications running on the end user device, one or more software integrated in an operating system of the end user device, and firmware integrated in the processor of the end user device;
processing the sensed inputs to determine one or more changes in parameters of the network for providing the particular quality of experience (QoE) by the network; and
providing the determined changes as feedback to a server connected to the network, wherein the server is configured to effect the one or more determined changes in the parameters of the network for providing the particular quality of experience (QoE).

10. The method of claim 9, wherein the sensed inputs comprise:
a. a bit rate and/or bandwidth provided by the network to determine if the requirements of the end user device for one or more of a minimum bit rate and a guaranteed bit rate are being met;
b. latency provided by the network to the end user device;
c. gaming parameters comprising load time and API latency that are obtained by interacting with a gaming application on the end user device;
d. a bit error rate and/or a packet error rate, as a part of Quality of Service (QoS) Class identifier (QCI); and
e. throughput provided by the network to the end user device.

11. The method of claim 10, wherein the sensing module is configured to measure the one or more sensed inputs.

12. The method of claim 9, wherein the determined one or more changes in the parameters of the network for providing the particular quality of experience (QoE) comprise changes to bandwidth provided by the network, latency provided by the network, throughput provided by the network, and bit rate provided by the network.

13. An end user device connected to a network, the end user device comprising:
a memory unit;
a processor operably coupled to the memory unit;
a client application comprising computer readable instructions of an application awareness algorithm stored in the memory unit of the end user device, wherein the computer readable instructions when executed by the processor of the end user device cause the processor to:
sense, using a sensing module, inputs from one or more sources, wherein the sources comprise one or more points in the network, one or more of a plurality of software applications running on the end user device, one or more software integrated in an operating system of the end user device, and firmware integrated in the processor of the end user device;
process, using a processing module, the sensed inputs to determine one or more changes in parameters of the network for providing a particular network slice by the network; and
provide, using an acting module, the determined changes as feedback to a server connected to the network, wherein the server is configured to effect the one or more determined changes in the parameters of the network for providing the particular network slice.

14. The end user device of claim 13, wherein the sensing module is further configured to sense one or more of:
gaming parameters comprising load time and API latency by interacting with a gaming application on the end user device;
video parameters comprising video start time, video end time, bandwidth required by the video, buffering durations and number of bufferings in a specific interval, video resolution, time when a video was paused, time when a video was resumed, and video genre by interacting with a software application that is playing the video on the end user device;
the one or more of the plurality of software applications running on the end user device by interacting with the operating system of the end user device to obtain identifiers of the one or more of the plurality of software applications, and wherein the sensed input comprises an identifier of the particular network slice;
an IP address of the end user device, and wherein the client application is further configured to associate the sensed IP address to a Mobile Subscriber International Subscriber Directory Number (MSISDN) of a user; and
parameters of the end user device comprising the operating system on the end user device, version of the operating system, display parameters of the end user device, and the memory parameters of the end user device.

15. The end user device of claim 13, wherein the inputs sensed by the sensing module comprise one or more of:
a) a bit rate and/or bandwidth provided by the network to determine if the requirements of the end user device for one or more of a minimum bit rate and a guaranteed bit rate are being met;
b) latency provided by the network to the end user device;
c) a bit error rate and/or a packet error rate, as a part of Quality of Service (QoS) Class identifier (QCI); and
d) throughput provided by the network to the end user device.

16. The end user device of claim 13, wherein the sensing module is further configured to sense one or more of:
a Policy Charging and Rules Function (PCRF) and sense the plans and subscriptions of the user to provide relevant information to a Complex Rules Engine as part of processing the sensed inputs; and
interact with a software application running in a cloud server, to obtain additional information regarding one or more of the sensed inputs, parameters of the end user device, and historical information.

17. The end user device of claim 13, wherein the sensed inputs and parameters of the end user device are processed in a cloud server along with Business logic, subscriber SLA and other relevant subscriber information of the user obtained from one or more of the content provider, telecom operator, a complex rules engine in order to enable the acting module to provide the determined changes as feedback to a server connected to the network.

18. The end user device of claim 13, wherein the acting module communicates to the server, the determined changes, wherein the determined changes comprise:
a) a request to a Network Slice Management Function (NSMF) of the network to request for a specific network slice for a software application, wherein the network slice is one of a maximum of eight slices which are simultaneously accessible by the end user device;
b) a specific Guaranteed Bit Rate (GBR) in a 5G network;
c) a specific Quality of Service for the 5G network (5QI) to assure a predetermined latency for the requirement of the one or more software applications; and
d) a specific delay-critical bearer.

19. The end user device of claim 13, wherein an Application Function utilizes the sensing module and the processing module to change User Equipment Route Selection Policies (URSP) rules in the end user device which associate the Applications and/or traffic types, to specific network slices, dynamically in real-time, via a Policy and Charging Control Framework (PCF).

20. An end user device operating system architecture for providing feedback to a network, the operating system comprising:
a plurality of computer readable instructions stored in a memory unit of the end user device;
wherein the computer readable instructions are configured to be executed by a processor of the end user device, and wherein the computer readable instructions when executed by the processor cause the processor to:
sense inputs from one or more of a plurality of software applications running on the end user device; and
provide the sensed inputs as feedback to a server connected to the network, wherein the server is configured to effect one or more changes in the parameters of the network.

21. The end user device operating system architecture of claim 20, wherein the computer readable instructions when executed by the processor further cause the processor to:
cause a sensing module that is integrated into the operating system to:
(a) sense the inputs from the one or more software applications running on the end user device, wherein the inputs comprise one or more of:
i. a bit rate and/or bandwidth provided by the network to determine if the requirements of the end user device for one or more of a minimum bit rate and a guaranteed bit rate are being met;
ii. latency provided by the network to the end user device;
iii. gaming parameters comprising load time and API latency that are obtained by interacting with a gaming application on the end user device;
iv. a bit error rate and/or a packet error rate, as a part of Quality of Service (QoS) Class identifier (QCI);
v. video parameters comprising video start time, video end time, bandwidth required by the video, buffering durations and number of bufferings in a specific interval, video resolution, time when a video was paused, time when a video was resumed, and video genre by interacting with a software application that is playing the video on the end user device; and
vi. throughput provided by the network to the end user device.

22. The end user device of operating system architecture of claim 20, wherein the feedback provided to the server comprises a request to effect one or more changes in the parameters of the network for providing a particular quality of experience (QoE) to the one or more software applications running on the end user device.

23. The end user device of operating system architecture of claim 20, wherein the feedback provided to the server comprises a request to effect one or more changes in the parameters of the network for providing a particular network slice to the one or more software applications running on the end user device.

24. An end user device connected to a network, the end user device a comprising:
memory unit;
a processor;
a memory unit operably coupled to the processor, wherein the memory unit comprises a client application comprising computer readable instructions of an application awareness algorithm that when executed by the processor cause the processor to:
sense inputs from one or more of a plurality of software applications running on the end user device; and
provide the sensed inputs to a server connected to the network, wherein the server is configured to effect one or more changes in the parameters of the network.

25. The end user device of claim 24, wherein the processor is one of a network processor and a main processor of the end user device.

26. The end user device of claim 24, wherein the computer readable instructions are part of a firmware stored in the memory unit.

27. The end user device of claim 24, wherein the feedback provided to the server comprises a request to effect one or more changes in the parameters of the network for providing a particular quality of experience (QoE) to the one or more software applications running on the end user device.

28. The end user device of claim 24, wherein the feedback provided to the server comprises a request to effect one or more changes in the parameters of the network for providing a particular network slice to the one or more software applications running on the end user device.

29. The end user device of claim 28, wherein the computer readable instructions when executed by the processor further cause the processor to:
cause a sensing module that is integrated into the firmware to:
(b) sense the inputs from the one or more software applications running on the end user device, wherein the inputs comprise one or more of:
i. a bit rate and/or bandwidth provided by the network to determine if the requirements of the end user device for one or more of a minimum bit rate and a guaranteed bit rate are being met;
ii. latency provided by the network to the end user device;
iii. video parameters of a video game application by interacting with a video game application on the end user device, when the processor is processing the video game;
iv. a bit error rate and/or a packet error rate, as a part of Quality of Service (QoS) Class identifier (QCI);
v. video parameters comprising video start time, video end time, bandwidth required by the video, buffering durations and number of bufferings in a specific interval, video resolution, time when a video was paused, time when a video was resumed, and video genre by interacting with a software application that is playing the video on the end user device and when the processor is processing the video; and
vi. throughput provided by the network to the end user device.

30. A web application configured to be downloaded on an end user device, comprising:
a sensing module comprising computer readable instructions configured to be executed by a processor of the end user device, and wherein the processor on execution of the computer readable instructions is configured to:
collect one or more inputs from one or more sources in the end user device; and
communicate the collected one or more inputs to a server comprising a peer software application.

31. The web application of claim 30, wherein the collected one or more inputs from one or more sources in the end user device comprise:
(a) one or more of a bit rate and bandwidth provided by the network to determine if the requirements of the end user device for one or more of a minimum bit rate and a guaranteed bit rate are being met;
(b) latency provided by the network to the end user device;
(c) one or more of a bit error rate and a packet error rate, as a part of Quality of Service (QoS) Class identifier (QCI); and
(d) throughput provided by the network to the end user device.

32. The web application of claim 31, wherein the sensing module is configured to measure the one or more collected inputs.

33. The web application of claim 30, wherein the server is configured to effect one or more changes in the parameters of the network for providing a particular quality of experience (QoE) to a user of the end user device, wherein the changes in the parameters of the network for providing the particular quality of experience (QoE) comprise one or more of:
a) changes to bandwidth provided by the network, latency provided by the network, throughput provided by the network, and bit rate provided by the network;
b) a specific Guaranteed Bit Rate (GBR) in a 4G and 5G network;
c) a specific Quality of Service for the 5G network (5QI) and in 4G network (QCI) to assure a predetermined latency for the requirement of the one or more software applications; and
d) a specific delay-critical bearer a in 5G network and dedicated bearer in a 4G network.
